(19) United States
(12) Patent Application Publication
(10) Pub. No.: US 2012/0009097 A1
(43) Pub. Date: Jan. 12, 2012

(54) FLOW PATH DEVICE

(75) Inventors: Takeki YAMAMOTO, Hyogo (JP); Masaya Nakatani, Hyogo (JP); Makoto Takahashi, Osaka (JP); Takami Ishida, Osaka (JP)

(73) Assignee: Panasonic Corporation, Osaka (JP)

(21) Appl. No.: 13/238,128

(22) Filed: Sep. 21, 2011

Related U.S. Application Data
(63) Continuation-in-part of application No. PCT/JP2010/002532, filed on Apr. 7, 2010.

(30) Foreign Application Priority Data
Apr. 20, 2009 (JP) JP 2009-101824

(51) Int. Cl. B01L 99/00

(52) U.S. Cl. 422/500

(57) ABSTRACT

A flow path device includes a substrate having a trench and columns extending from a bottom of the trench. The trench is configured to have a fluid flowing therein. Each of columns has a side surface having grooves formed therein. The grooves have an annular shape or an arcuate shape. This flow path device reduces damage to the columns, and has a high reliability.

This application is a continuation-in-part of International Application PCT/JP2010/002532, filed Apr. 7, 2010, the contents of which are incorporated herein by reference.

### TECHNICAL FIELD

The present invention relates to a flow path device to be used for, e.g. a micro reactor and a micro pump.

### BACKGROUND ART

A flow path device is installed in, e.g. a micro reactor analyzing protein including antigen, DNA, blood, glucide, and lipid, and a micro pump dripping or delivering a micro fluid.

A conventional flow path device includes a substrate and a trench. The trench is formed in a surface of the substrate and constitutes a flow path. Columns are formed on a bottom of the trench for various purposes. For instance, the columns are used for filtering particles or for used as a fixing area having an object to be measured fixed thereon.

Such flow path device is described in Patent Literatures 1 and 2.

The columns may be broken or chipped due to an impact from flowing fluid. Being broken or chipped, the columns may deteriorate their function, or broken chips become dust and choke a flow of the fluid, reducing a reliability of the flow path device.

### CITATION LIST

### Patent Literature

Patent Literature 1; Japanese Patent Laid-Open Publication No. 2008-39541

Patent Literature 2: Japanese Patent Laid-Open Publication No. 2006-300726

### SUMMARY OF THE INVENTION

A flow path device includes a substrate having a trench and columns extending from a bottom of the trench. The trench is configured to have a fluid flowing therein. Each of columns has a side surface having grooves formed therein. The grooves have an annular shape or an arcuate shape.

This flow path device reduces damage to the columns, and has a high reliability.

### BRIEF DESCRIPTION OF THE DRAWINGS

FIG. 1 is a top view of a flow path device according to Exemplary Embodiment 1 of the present invention.

FIG. 2A is a cross sectional view of the flow path device taken along line 2A-2A shown in FIG. 1.

FIG. 2B is a cross sectional view of the flow path device taken along line 2B-2B shown in FIG. 1.

FIG. 2C is a cross sectional view of the flow path device taken along line 2C-2C shown in FIG. 1.

FIG. 3 is an enlarged view of the flow path device according to Embodiment 1.

FIG. 4A is a schematic view of the flow path device according to Embodiment 1.

FIG. 4B is an enlarged view of the flow path device according to Embodiment 1.

FIG. 5 is an enlarged view of the flow path device according to Embodiment 1.

FIG. 6 is a cross sectional view of the flow path device according to Embodiment 1 for illustrating a process for manufacturing the device.

FIG. 7 is a cross sectional view of the flow path device according to Embodiment 1 for illustrating a process for manufacturing the device.

FIG. 8 is a cross sectional view of the flow path device according to Embodiment 1 for illustrating another process for manufacturing the device.

FIG. 9A is a cross sectional view of another flow path device according to Embodiment 1.

FIG. 9B is a cross sectional view of still another flow path device according to Embodiment 1.

FIG. 10 is a top view of a flow path device according to Exemplary Embodiment 2 of the invention.

FIG. 11 is a cross sectional view of the flow path device taken along line 11-11 shown in FIG. 10.

FIG. 12 is a cross sectional view of another flow path device according to Embodiment 2.

### DETAILED DESCRIPTION OF PREFERRED EMBODIMENTS

### Exemplary Embodiment 1

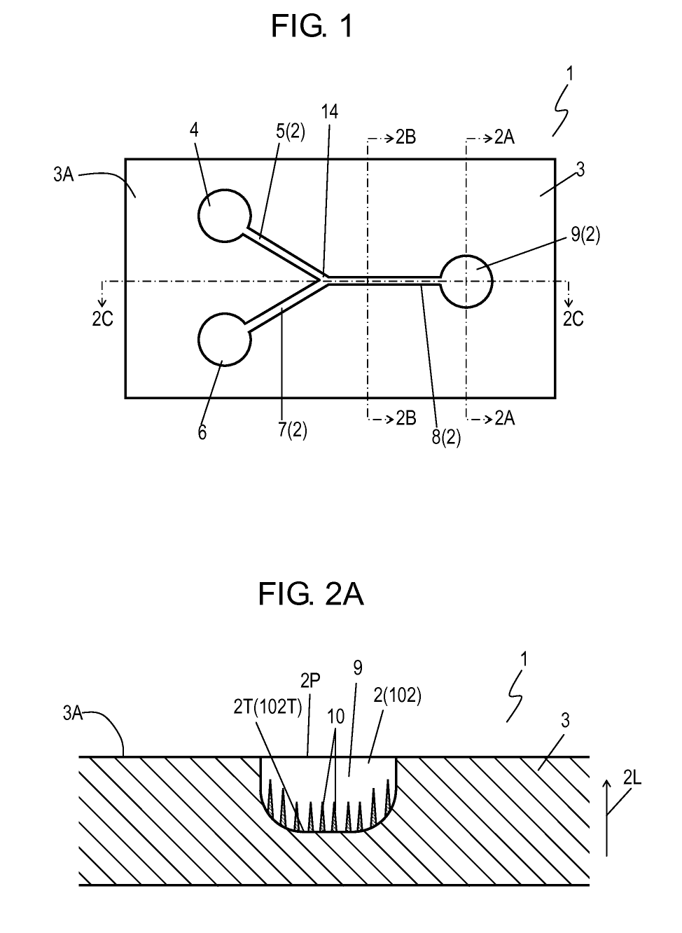

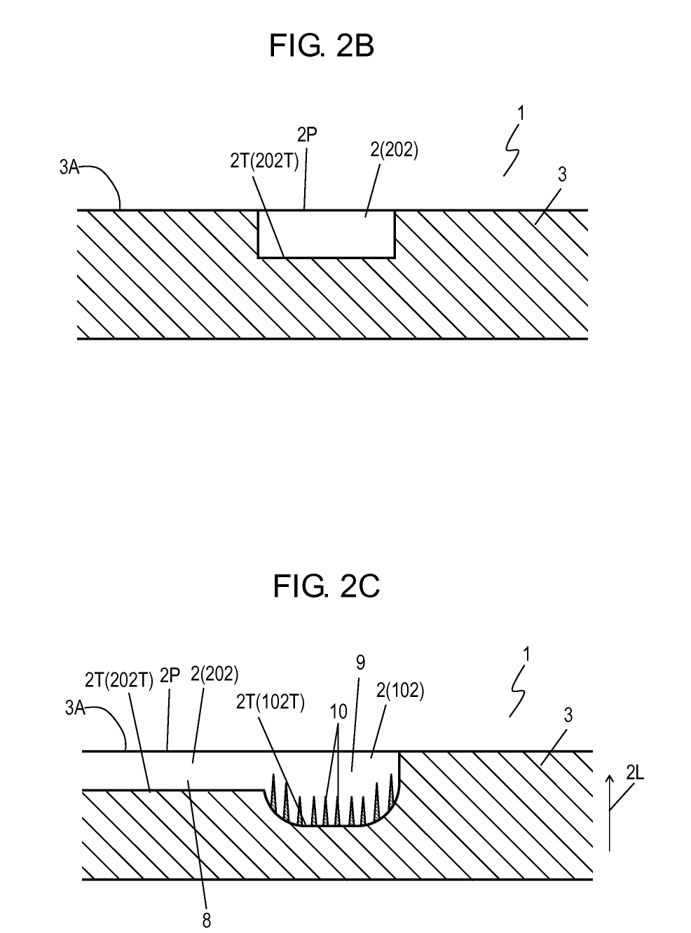

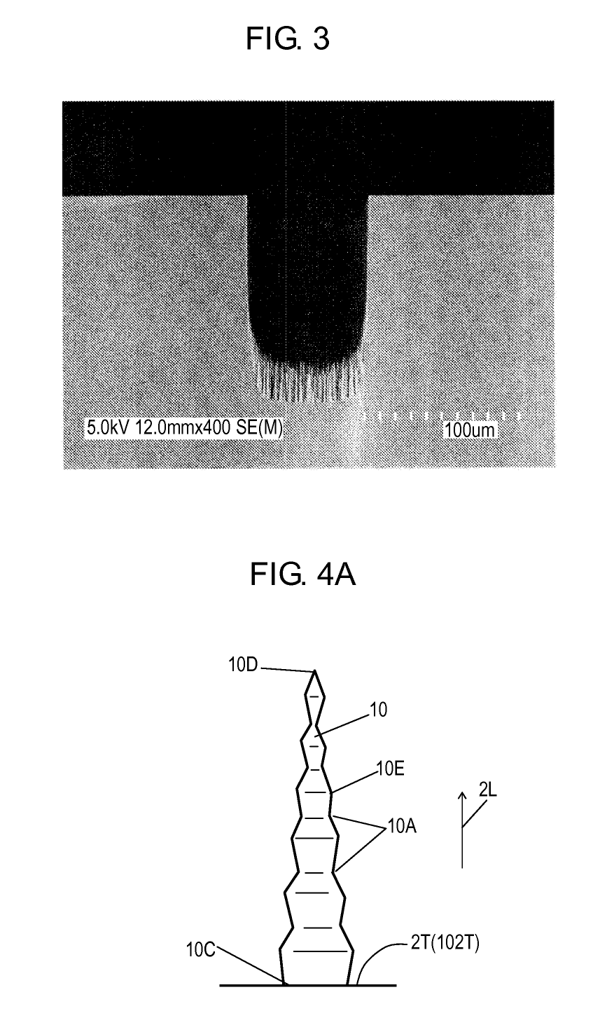

FIG. 1 is a top view of flow path device 1 in accordance with Exemplary Embodiment 1 of the present invention. FIGS. 2A, 2B and 2C are cross sectional views of the flow path device taken along lines 2A-2A, 2B-2C and 2C-2C shown in FIG. 1. FIG. 3 is an enlarged view of flow path device 1 which is a picture taken with a scanning electron microscope (SEM). Flow path device 1 according to Embodiment 1 is used for a micro reactor analyzing an antigen-antibody reaction.

Flow path device 1 includes substrate 3 having surface 3A having trench 2 formed therein. Trench 2 has inlet path 5 connected to inlet port 4, inlet path 7 connected to inlet port 6, merging path 8 connected to inlet paths 5 and 7, and measuring area 9 connected to merging path 8. Inlet path 5, 7 and merging path 8 are connected at confluence 14. Trench 2 has bottom 2T and opening 2P which opens at surface 3A. Fluid flows in parallel with bottom 2T in trench 2.

As shown in FIG. 2C, portion 102 of trench 2 constituting measuring area 9 is deeper than portion 202 of trench 2 constituting each of inlet path 5, 7 and merging path 8. Trench 2 has bottom 2T. Bottom 2T has portions 102T and 202T. Portion 102T is a bottom of portion 102 constituting measuring area 9 of trench 2. Portion 202T is a bottom of portion 202 constituting inlet path 5, 7 and merging path 8 of trench 2. As shown in FIGS. 2A and 2C, columns 10 are formed at portion 102 of trench 2 constituting measuring area 9. Columns 10 extend from portion 102T of bottom 2T toward opening 2P in longitudinal direction 2L.

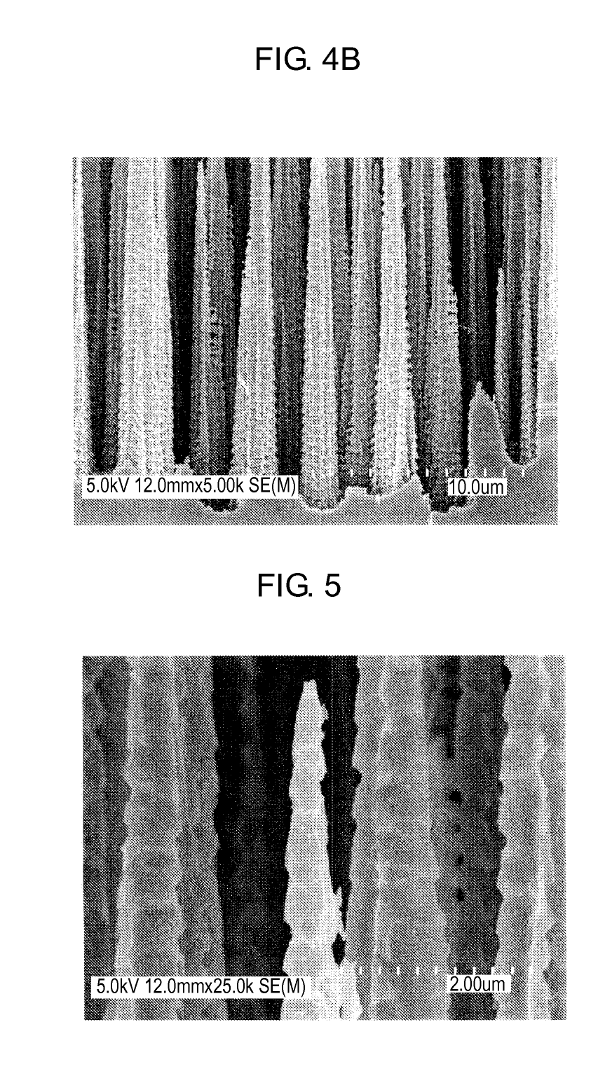

FIG. 4A is a schematic depiction of column 10. FIGS. 4B and 5 are enlarged views and a SEM picture of columns 10. Columns 10 extend to tip 10D in longitudinal direction 2L from base 10C connected to portion 102T of bottom 2T of trench 2. Tip 10D opens freely. Base 10C is thicker than tip 10D, and thus, column 10 has substantially a conical shape having a bottom at base 10C and a peak at tip 10D. Plural grooves 10A are formed in side surface 10E of the conical shape of column 10. Groove 10A extends perpendicularly to longitudinal direction 2L, and has a closed annular loop shape. The grooves may have an unclosed arcuate shape. Grooves 10A may include grooves having the annular loop shape and grooves having the arcuate shape. The fluid which flows in trench 2T in parallel with bottom 2T flows around column 10. Grooves 10A extend along a direction in which the fluid flows around column 10.

According to Embodiment 1, substrate 3 is made of single-crystal silicon substrate, but may be made solely of silicon, such as polycrystalline or amorphous, or may be made of a so-called silicon-on-insulator (SOI) substrate including a silicon dioxide layer is sandwiched by silicon layers. These silicon materials may be processed precisely by a dry etching method, and provide flow path device 1 with a small size having a microscopic and intricate trench.

Column 10 is made of silicon. Column 10 and bottom 2T of trench 2 are bonded unitarily by covalent bonding. Column 10 and substrate 3 are formed into one piece by the covalent bonding not by conventional bonding, hence providing column 10 having a high mechanical strength.

According to Embodiment 1, substrate 3 has a thickness ranging from 300 μm to 1 mm, and trench 2 has a depth ranging from 30 μm to 300 μm. Portion 102 of trench 2 is deeper than portion 202, the difference of the depths of portions 102 and 202 is larger than the height of column 10. Namely, column 10 protruding from portion 102T of bottom 2T of trench 2 does not exceed a height at portion 202T of bottom 2T, as shown in FIG. 2C.

Column 10 is shorter than a depth of portion 102 of trench 2, preferably shorter than 2/3 of the length. Base 10C of column 10 has a diameter ranging from 1.5 μm to 2 μm while tip 10D has a diameter ranging from 0.1 μm to 0.2 μm. Base 10C of column 10 is separated from base 10C of adjacent column 10 by about 2 μm.

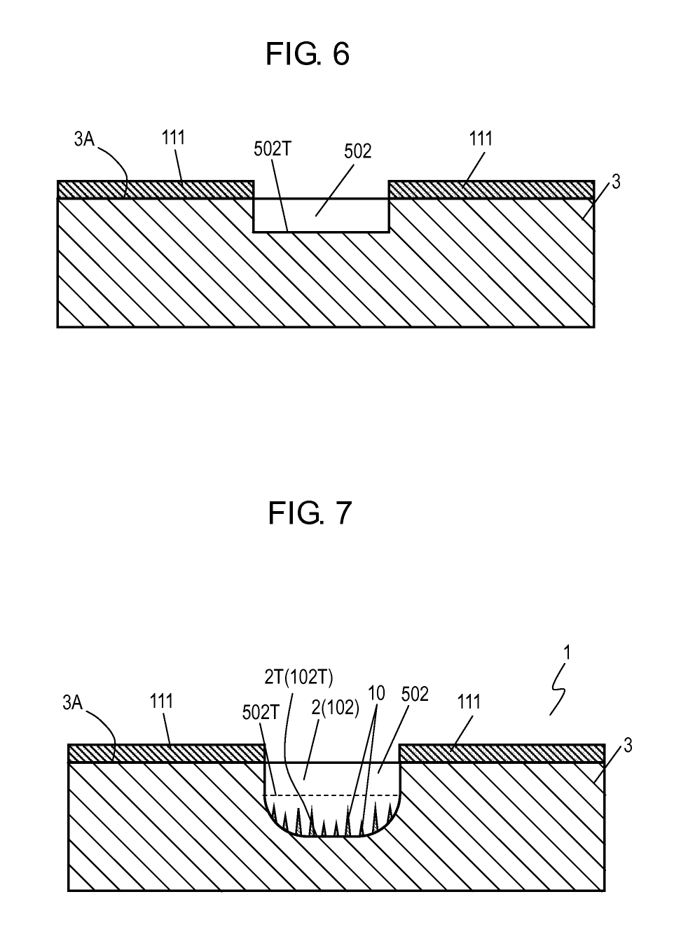

Next, a method of manufacturing flow path device 1 will be described below. FIGS. 6 and 7 are cross sectional views of flow path device 1 for illustrating the method of manufacturing flow path device 1. According to Embodiment 1, flow path device 1 is manufactured by a dry etching method with an etching gas for facilitating an etching process and an etching suppressing gas for suppressing the etching process which are alternately used. SF₆, CF₄, NF₃, or XeF₂ can be used as the etching gas. CF₄, CHF₃, C₂F₆, C₃F₈, or C₄F₈ can be used as the etching suppressing gas.

First, surface 3A of substrate 3 is covered with mask 111 as shown in FIG. 6. Then, plasma is generated over mask 111 by an inductive coupling method utilizing an external coil, and then, an etching gas is introduced into the plasma, and produces fluorine radical. The fluorine radical reacts with substrate 3, and chemically etches surface 3A of substrate 3.

At this moment, a high frequency wave is applied to substrate 3 to generate a negative bias voltage on substrate 3. This bias voltage causes a positive ion contained in the etching gas to collide perpendicularly with surface 3A of substrate 3. This ion bombardment or the collision physically etches surface 3A of substrate 3. This dry etching forms the trench perpendicularly into surface 3A of substrate 3.

Then, the etching gas is stopped supplying, and then, the etching suppressing gas is injected instead. At this moment, the high frequency wave is not applied to substrate 3 not to generate the bias voltage on substrate 3. Resultantly, positive ion like Cf⁺ contained in the etching suppressing gas does not electrically deflect but is attached to a side wall of a hole of substrate 3 which is formed by the etching, thereby forming a uniform protective coat on the side wall of the hole.

The protective coat formed by the positive ion in the etching suppressing gas prevents the etching from proceeding. The protective coat is formed not only on the side wall of trench 2, but also on a bottom of the trench. The protective coat formed on the bottom is easily eliminated by ion bombardment than the protective coat formed on the side wall, accordingly allowing the etching process by the etching gas to proceed to the bottom of the trench.

Thus, the etching process by the etching gas and the coating process of the protective coat by the etching suppressing gas are alternately repeated, thereby forming trench 502 in surface 3A of substrate 3, as shown in FIG. 6. Trench 502 includes inlet path 5, 7 and merging path 8 in flow path device 1 according to Embodiment 1.

Next, as shown in FIG. 7, trench 2 is formed by selectively etching a portion of the substrate constituting measuring area 9 of trench 502, but not a portion constituting inlet path 5 or 7 or merging path 8. The bottom of trench 502 is etched deeply further to form trench 2. At this moment, the etching process for forming trench 502 shown in FIG. 6 is weakened to form columns 10 on portion 102T of bottom 2T of trench 2. The etching can be weakened by reducing the concentration of the etching gas, by increasing a pressure of the etching gas, by reducing the bias voltage, by reducing a duty ratio which is the ratio of a duration of applying the bias voltage to a duration of not applying the bias voltage while introducing the etching gas, by reducing a ratio of a time for introducing the etching gas to a time for introducing the etching suppressing gas, or by reducing electric field strength of the plasma for the etching.

Columns 10 having the conical shape may be formed also by thickening the protective coat formed by the etching suppressing gas. The thick protective coat provides a similar effect due to the weakening of the etching process. The protective coat can be thickened by increasing the concentration of the etching suppressing gas, increasing a ratio of a time for introducing the etching suppressing gas to a time for introducing the etching gas, or by increasing electric field strength of the plasma.

The above methods allow nonvolatile material generated in the etching process to remain not etched and to stays at the bottom of trench 502 to become a micro mask forming column 10 having the conical shape.

Columns 10 can be formed by backscattering the nonvolatile material generated in the etching process. Being backscattered, once etched nonvolatile material is adsorbed again by the bottom of trench 502 to become the micro mask. The nonvolatile material can be backscattered by increasing the pressure of the etching gas, by increase the bias voltage, or by increase the duty ratio.

As mentioned, by controlling a condition to weaken the etching, trench 2 having columns 10 can be formed.

Grooves 10A having the annular loop shape or the arcuate shape are formed in side surface 10E of column 10G by repeating the etching process and the process for forming protective coat.

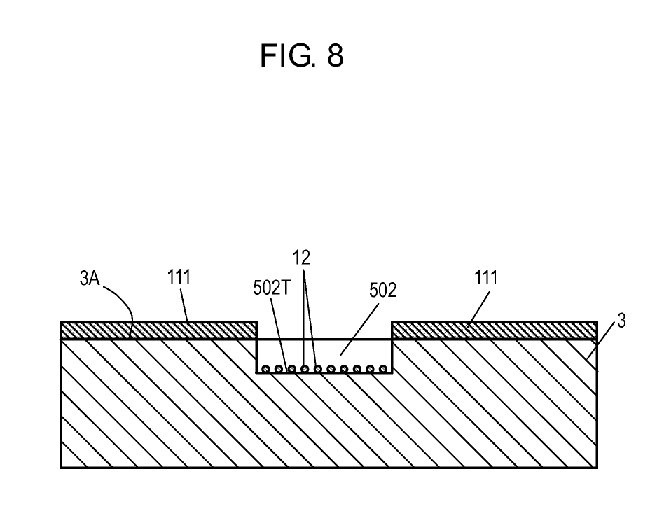

FIG. 8 is a cross sectional view of flow path device 1 for illustrating another method of manufacturing the device. In FIG. 8, components identical to those shown in FIG. 6 are denoted by the same reference numerals. After forming trench 502A, core 12 made of silicon oxide, such as SiO₂ or SiOF, on bottom 502T of trench 502, as shown in FIG. 8. Then, the etching process and the protective coat forming process are repeated as described above to form trench 2 and column 10 shown in FIG. 7. Core 12 is made of material having an etching rate lower than that of silicon etched by the etching gas, so that core 12 serves as a mask for forming columns 10. By weakening the etching, columns 10 having the conical shape can be formed efficiently.

Portion 102 of trench 2 having column 10 formed thereon may be deeper and/or narrower than other portions. This structure causes columns 10 to grow longer and to be formed easily. Portion 102 being narrower provides effects, such as the reducing of an amount of sample fluid, the reducing of a diffusion time, the reducing of a time for mixing the liquid, and increasing of chemical reaction efficiency and heat efficiency. In this case, a reaction product insoluble to solvent and an insoluble matter mixed to reactive substrate may clog the flow path. However, columns 10 function as a filter to reduce such unnecessary matters.

If portion 102 of the flow path is deep, the path is produced easily in three dimensions and an optical path length is shortened, so that a microscopic observation becomes easy and which enhances sensitivity of the device. If the flow path is deep, a solvent can be hardly mixed in a depth direction. In the flow path device according to embodiment 1, however, liquid flows along columns 10 and diffuses the solvent. Since side surface 10E of column 10 having the conical shape inclines from bottom 2T (102T) to the tip with regard to the flow of the liquid, the liquid is easily diffused along side surface 10E, hence being effectively mixed even in the depth direction.

Flow path device 1 may be used as a micro reactor for analyzing an antigen-antibody reaction, in which plural antibodies is fixed onto portion 102T of bottom 2T of trench 2 constituting measuring area 9. Columns 10 formed on the bottom of trench 2 provide portion 102T of bottom 2T of trench 2 with a large surface area. This structure allows a large amount of antibody to be fixed onto both portion 102T of bottom 2T and columns 10. After the antibody is fixed, enzyme-modified antigen is introduced from inlet port 4 to bind the antigen with the antibody. Then, a substance which changes in color by enzyme reaction is introduced from inlet port 6. The amount of the antigen is measured based on the change of the color of the substance. According to this embodiment, the antibody is fixed densely to columns 10 and increases a detection signal, accordingly providing a precise measurement.

In flow path device 1 according to Embodiment 1, grooves 10A are formed along side surface 10E of each column 10. Grooves 10A are substantially in parallel with the flowing direction of the fluid, hence reducing friction against the fluid.

Column 10 having tip 10D thinner than base 10C reduces the pressure from the fluid to the tip. Thus, column 10 receives a small stress from the flowing fluid, and is prevented from being damaged, thus providing flow path device 1 with high reliability.

Column 10 made of silicon. Silicon can be processed easily, hence providing fine column 10. On the other hand, silicon cleaves easily so the column is likely broken. In flow path device according to Embodiment 1, however, even when column 10 is delicately formed, damage to the column is controlled, so it is useful to realize miniaturization of flow path device 1.

In the device according to Embodiment 1, trench 2 is formed by weakening the etching, hence connecting the side surface of trench 2 moderately to bottom 2T in a gently-sloping curve. Even after column 10 is formed, the trench can be filled easily with the liquid, and have bubbles hardly produced.

After columns 10 is formed, substrate 3 may be thermal-oxidized at a temperature ranging from 800° C. to 1400° C. to form a high hydrophilic silicon dioxide film on both a surface of column 10 and trench 2. The silicon dioxide film prevents the bubble from being produced, and makes columns 10 stronger. The thermal oxidization process may be performed in an open air, in an oxygen atmosphere, or in vapor.

According to Embodiment 1, columns 10 have the conical shape, but may have a circular columnar shape, a rectangular columnar shape, or a pyramid shape. Regardless of the shape, grooves 10A in side surface 10E of each column 10 provide the same effects.

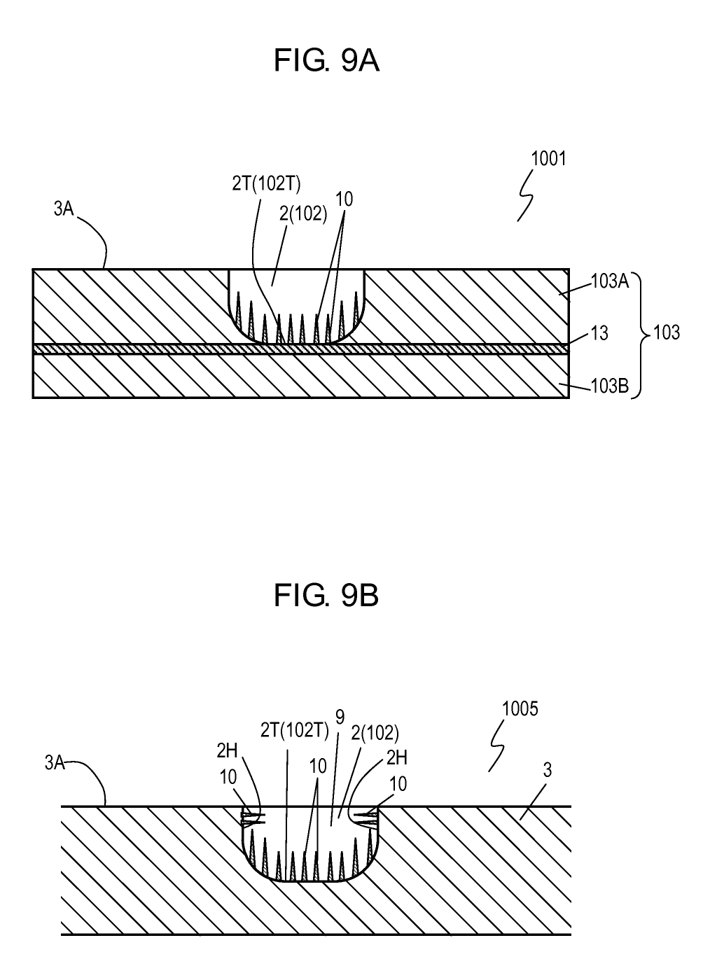

FIG. 9A is a cross sectional view of another flow path device 1001 according to Embodiment 1. In FIG. 9A, components identical to those of flow path device 1 shown in FIG. 2A are denoted by the same reference numerals. Flow path device 1001 shown in FIG. 9A includes substrate 103 made of an SOI substrate instead of silicon substrate 3 shown in FIG. 2A. SOI substrate 103 includes silicon layer 103A having surface 3A, silicon layer 103B, and silicon dioxide layer 13 sandwiched between silicon layers 103A and 103B. As shown in FIG. 9A, trench 2 is formed by continuing etching surface 3A until the silicon dioxide layer is exposed. Exposed bottom 2T of trench 2 is made of silicon dioxide having high hydrophilicity, and prevents bubbles from being produced with the flowing fluid even if columns 10 are formed.

FIG. 9B is still another flow path device 1005 according to Embodiment 1. In FIG. 9A, components identical to those of flow path device 1 shown in FIG. 2A are denoted by the same reference numerals. In flow path device 1 shown in FIG. 2A, columns 10 extend from portion 102T of bottom 2T of trench 2. In flow path device 1005 shown in FIG. 9B, columns 10 extend also from side surface 2H of trench, providing the same effects as flow path device shown in FIG. 2A.

### Exemplary Embodiment 2

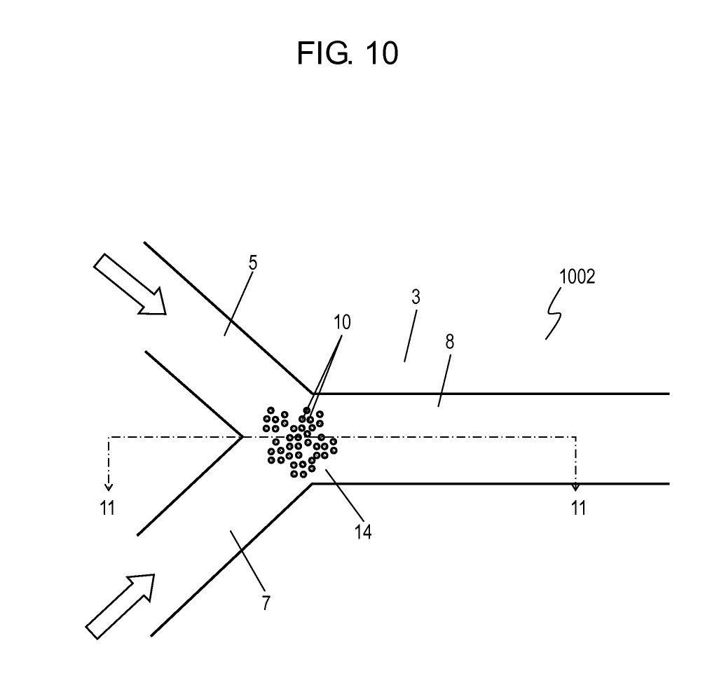

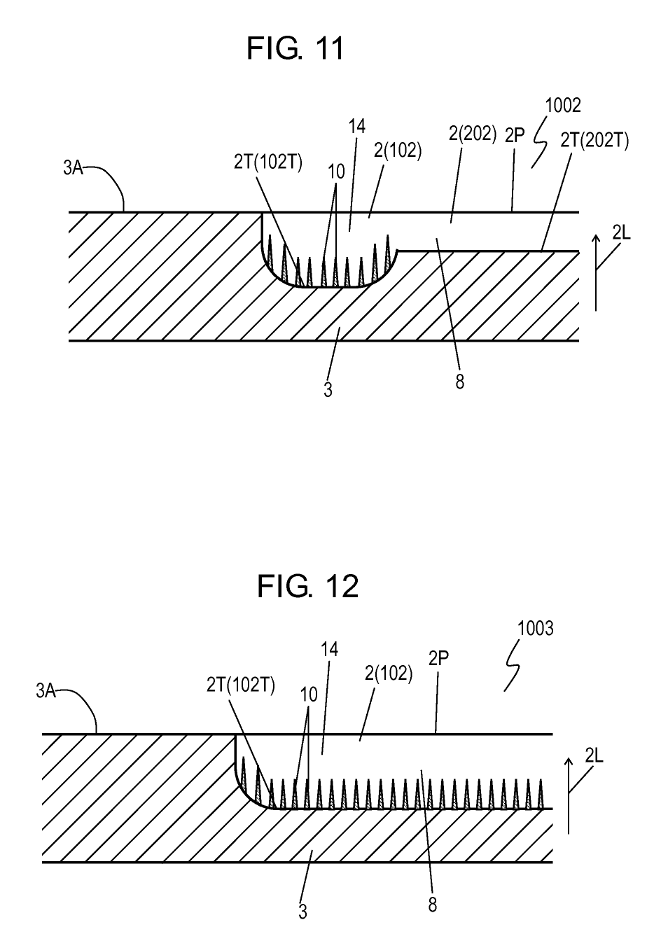

FIG. 10 is a top view of flow path device 1002 according to Exemplary Embodiment 2. FIG. 11 is a cross sectional view of flow path device 1002 taken along line 11-11 shown in FIG. 10. In FIGS. 10 and 11, components identical to those of flow path device 1 according to Embodiment 1 shown in FIGS. 1 and 2A to 2C are denoted by the same reference numerals.

In flow path device 1002 shown in FIG. 10, columns 10 are formed selectively at confluence 14 where inlet paths 5 and 7 join to merging path 8. As shown in FIG. 11, trench 2 has portion 102 constituting confluence 14, and portion 202 constituting inlet paths 5 and 7 and merging path 8. Portion 102 of trench 2 is deeper than portion 202. Columns 10 are formed selectively on portion 102 of trench 2, but not on portion 202.

Column 10 has tip 10D and base 10C thicker than tip 10D. Annular shape grooves 10A formed on side face 10E, which is similar to embodiment 1 in FIG. 4A.

Column 10 formed at confluence 14 agitates a laminar flow caused at merging path 8, thereby increasing uniformity of a fluid in the flow path. High uniformity of the fluid causes a chemical reaction to occur precisely at measuring area 9 (FIG. 1) and increases a reaction speed of the chemical reaction. This also provides other effect identical to those of flow path device 1 according to Embodiment 1.

FIG. 12 is a cross sectional view of another flow path device 1003 according to Embodiment 2. In FIG. 12, components identical to those of fluid flow devices 1 and 1002 shown in FIGS. 1, 2A to 2C, 10 and 11 are denoted by the same reference numerals. In flow path device 1003 shown in FIG. 12, columns 10 are formed on the entire portion of bottom 2T constituting trench 2, inlets 5 and 7, merging path 8, and measuring area 9. This arrangement provides the same effects as flow path devices 1 and 1002.

Flow path devices 1, 1001, 1002 and 1003 are used not only for a micro reactor but for other instrument having a fluid flowing path, such as a micro pump, raising a reliability of the instrument.

### INDUSTRIAL APPLICABILITY

A flow path device according to the present invention prevents columns from having damage and has high reliability, hence being useful for an instrument, such as a micro reactor and a micro pump, having a fluid flow path.

### REFERENCE MARKS IN THE DRAWINGS

2 Trench
3 Substrate
5 Inlet Path (First Inlet Path)
7 Inlet Path (Second Inlet Path)
8 Merging Path
10 Column
10A Groove
10E Side Surface
10C Base
10D Tip
14 Confluence
102 Portion (First Portion) of Trench 2
202 Portion (Second Portion) of Trench 2

1. A flow path device comprising:
a substrate having a trench formed therein, the trench being configured to have a fluid flowing therein; and
a plurality of columns extending from a bottom of the trench,
wherein each of the plurality of columns has a side surface having a plurality of grooves formed therein, the plurality of grooves having an annular shape or an arcuate shape.

2. The flow path device according to claim 1, wherein each of the plurality of columns has a base connected to the bottom of the trench and a tip thinner than the base.

3. The flow path device according to claim 1, wherein the plurality of grooves are formed around each of the plurality of columns and along a direction in which the fluid flows.

4. The flow path device according to claim 3, wherein each of the plurality of columns has a base connected to the bottom of the trench and a tip thinner than the base.

5. The flow path device according to claim 1,
wherein the trench has a first portion and a second portion, the first portion of the trench have the plurality of columns formed thereon, the second portion of the trench not having the plurality of columns formed thereon, and
wherein the first portion of the trench is deeper than the second portion of the trench.

6. The flow path device according to claim 1,
wherein the trench has a first inlet path introducing a fluid, a second inlet path introducing a fluid, and a merging path connected to the first inlet path and the second inlet path at a confluence,
wherein the plurality of the columns are selectively formed at the confluence.
